(19) United States
(12) Patent Application Publication
(10) Pub. No.: US 2026/0168844 A1
(43) Pub. Date: Jun. 18, 2026

(54) Method for the energy-efficient operation of a wireless monitoring sensor and correspondingly arranged monitoring sensor

(71) Applicant: Balluff GmbH, Neuhausen a.d.F. (DE)

(72) Inventors: Felix GRIMM, Waiblingen (DE); Christoph BOCKENHOFF, Neuhausen (DE); Dominik NILLE, Baltmannsweiler (DE); Albert DORNEICH, Ostfildern (DE)

(21) Appl. No.: 19/411,453

(22) Filed: Dec. 8, 2025

(30) Foreign Application Priority Data
Dec. 13, 2024 (DE) 102024137700.3

(51) Int. Cl. G01H 3/14; G01P 15/08

(52) U.S. Cl. CPC G01H 3/14; G01P 15/08; G01P 2015/0865

(57) ABSTRACT

In the method for the energy-efficient operation of a wireless monitoring sensor for detecting time measurements described here, provision is made in particular for measured time values detected by the monitoring sensor in the time domain to be transformed into the frequency domain in order to generate a frequency-dependent amplitude and phase spectrum in a predetermined frequency range, for the overall size of data in the frequency range to be reduced by compression, with inter alia bit data of the same data size being combined to form a bit sequence, for bit sequences or bit ranges having the same number of significant bits to be reduced and combined and for the combined bit sequences to be decoded again by the recipient and analysed in the frequency or time domain.

### BACKGROUND

### Field of the Invention

The invention relates to a method for the energy-efficient operation of a wireless monitoring sensor or “condition monitoring” sensor, in particular of a wirelessly operating vibration sensor, and a correspondingly configured sensor.

### Prior Art

Known “condition monitoring” sensors detect different physical variables such as vibration, temperature, humidity and/or ambient pressure of a technical facility. Vibrations are detected in particular with the aid of MEMS-based acceleration sensors. This enables the technical condition of, for example, a machine, an industrial plant and associated components to be monitored. Monitoring means that faulty components can be replaced before they bring the machine to a standstill. These monitoring sensors therefore enable trouble-free operation of such a machine or plant/facility and thereby significantly increase its effectiveness.

In particular, wireless vibration sensors are known which have a limited battery life. In the case of these sensors, detected vibration data are wirelessly transmitted in unprocessed form, with the wireless transmission of the raw data, for example of time series data, resulting in comparatively high energy consumption. Battery lives are therefore currently only about five to ten years, with substantially longer battery lives being desired in particular in commercial or industrial fields, in particular for safety and/or maintenance reasons.

### DISCLOSURE OF THE INVENTION

The object of the invention is to minimize the energy consumption of battery-operated wireless sensors concerned here.

To achieve this object, the invention is based on the idea, in the case of a wireless monitoring sensor concerned here, of first suitably compressing the detected sensor data that is to be transmitted. A monitoring sensor wirelessly transmitting such data with such data compression integrated in the sensor has considerably improved energy efficiency and therefore a considerably extended battery life of well over ten years or even longer.

According to a first aspect of the method according to the invention for the energy-efficient operation of a wireless monitoring sensor concerned here for detecting preferably time-dependent measurements, provision is made in particular for the detected time values to be digitalized, for measured time values detected by the monitoring sensor in the time domain to be transformed into the frequency domain in order to generate a frequency-dependent amplitude and phase spectrum in a predetermined frequency range, for the overall size of data in the frequency range to be reduced by compression, with bit data of the same data size being combined to form a bit sequence, and for bit sequences or bit ranges having the same number of significant bits, that is to say having the same number of leading zeros, to be reduced by precisely that number of leading zeros and combined and wirelessly transmitted to the recipient. The combined bit sequences are decoded again by the recipient, with the data added or supplemented again with the reduced leading zeros.

According to a second aspect of the method according to the invention, provision may be made for the compressing of the bit data resulting from the digitalization to be carried out using a “run-length binary encoding” method.

According to a further aspect of the method according to the invention, provision may further be made for the data size of a bit sequence and the data sizes of existing bit sequences with a similar number of leading zeros to be standardized before compression.

According to a further aspect of the method according to the invention, provision may also be made here for an amplitude threshold to be determined on the basis of the amplitude spectrum, with only amplitudes above the amplitude threshold being transmitted to the recipient.

According to a further aspect of the method according to the invention, provision may be made for the determined amplitude threshold to be determined as a multiple of an amplitude mean value ascertained from the amplitude spectrum.

According to a further aspect of the method according to the invention, provision may be made for a predetermined number of measured values to be detected in the time domain, for the detected measured values to be transformed into the frequency domain by means of Fourier transformation, for bit sequences to be standardized in respect of their data size, and for the resulting bit sequences to be wirelessly transmitted to the recipient.

According to a further aspect of the method according to the invention, provision may be made, when sequences are being formed, for not all possible data sizes to be permitted, with data sizes being rounded to respective permitted values before standardization of the data size. For example, if only 8 data sizes are permitted instead of 16, then 3 bits instead of 4 can be used to transmit the data size. In essence, the actual measured values (for example acceleration values) are not changed or rounded when standardizing the data size.

According to a further aspect of the method according to the invention, provision may be made for preferably only the run length of the bit sequences, the data size of the bit sequences and significant bits to be transmitted to the recipient.

According to a further aspect of the method according to the invention, provision may be made for the data resulting from the transformation into the frequency domain to be compressed by deleting frequency components with relatively or comparatively small amplitudes. Provision may further be made here for a list of the deleted or undeleted frequencies also to be transmitted.

According to a further aspect of the method according to the invention, provision may be made for all of the frequency components whose amplitude value is below the amplitude threshold to be deleted from the data resulting from the transformation into the frequency domain.

According to a further aspect of the method according to the invention, provision may be made, instead of transmitting a complex spectrum, that is to say including real and imaginary parts, for only the amplitude values themselves to be transmitted, with a list of the deleted or undeleted frequencies also being transmitted.

According to a further aspect of the method according to the invention, provision may be made for amplitude values to be formed from the real and imaginary parts and the complete amplitude spectrum formed in this way to be transmitted.

According to a further aspect of the method according to the invention, provision may be made for bit sequences with a standardized data size to be formed and only the run length, the data size and the significant bits to be transmitted.

According to a yet further aspect of the method according to the invention, provision may be made for the amplitude spectrum generated by the transformation into the frequency domain to be analysed directly by the recipient of the transmitted bit data or transformed back into the time domain.

In the wireless monitoring sensor according to the invention for detecting temporally periodic measurements, provision is made in particular for a microcontroller for the energy-efficient operation of the monitoring sensor according to the previously described method.

The data compression according to the invention significantly reduces the amount of data transmitted wirelessly from the sensor to a data recipient, for example to a gateway. This data reduction therefore also reduces the sensor's energy consumption and thus extends its battery life.

Furthermore, the data compression does not limit the bandwidth available for data transmission. Several or even a large number of sensor nodes can therefore be included or integrated into a wireless sensor network. Such a sensor network includes several sensor nodes which cooperate either in an infrastructure-based or in a self-organizing “ad hoc” network. A single sensor node consists of one or more sensors, a processor and a data storage unit, as well as a wireless communication module. All of these components are powered by one or more batteries, with the existing invention also being able to significantly extend the battery life or lives of such a sensor node.

The invention is particularly advantageous for compressing the vibration data provided by a vibration sensor since, in the corresponding spectral or frequency domain, the vibration energy is concentrated in only a few frequency domains and the remaining frequency domains assume only (relatively) small amplitude values. The invention can also be advantageously applied to a correspondingly performed evaluation of current and voltage values in the case of performance monitoring of a monitoring sensor concerned here.

In addition, depending on the characteristics of the data, the data size and run length can also advantageously be specified in fewer than the actual bits, for example with binary “100”=4, the data size being 8 since run times starting from 4 bits are included in this case. This also saves a large number of bits in the compression concerned herein.

### BRIEF DESCRIPTION OF THE DRAWINGS

Exemplary embodiments of the invention are illustrated in the drawings and explained in more detail in the following description.

FIG. 1 shows the amplitude spectrum of a vibration sensor as an example of a monitoring or “condition monitoring” sensor concerned here;

FIG. 2 shows a first exemplary embodiment of the compression method according to the invention;

FIG. 3 shows original complex frequencies to illustrate the standardization of the data size according to the invention;

FIG. 4 shows an example of compressed data after a standardization of the data size according to the invention;

FIG. 5 shows a numerical example of standardization for three consecutive (bit) sequences;

FIG. 6 shows a second exemplary embodiment of the compression method according to the invention in which small frequency components are deleted;

FIG. 7 shows a third exemplary embodiment of the compression method according to the invention in which all of the amplitudes which are smaller than a threshold value or mean value are deleted;

FIG. 8 shows an example of the calculation of the RMS value of a vibration for the purposes of error analysis;

FIG. 9 shows a fourth exemplary embodiment of the compression method according to the invention, that is to say using an amplitude spectrum;

FIG. 10 shows a modification or supplementing of the fourth exemplary embodiment shown in FIG. 9.

### EXEMPLARY EMBODIMENTS OF THE INVENTION

Due to developments and trends in the “internet of things”, the resulting “wireless sensor networks” and the “industrial internet of things”, there is a growing demand for wireless, energy-efficient sensors with the longest possible battery life.

Miniaturized “MEMS” sensors are particularly suitable for detecting movements and vibrations. These sensors can detect mechanical, magnetic or even chemical changes and convert them into electrical information. Depending on their design, these sensors can measure pressure, acceleration, gas flow or light levels.

In industrial applications, corresponding vibration sensors can be used for condition monitoring (what are referred to as “condition monitoring” sensors) and predictive maintenance (what are referred to as “predictive maintenance” sensors), thus preventing machine downtime, for example. In addition, corresponding wireless sensors can be used for retrofitting solutions without requiring subsequent wiring installations.

In order to extend maintenance intervals for battery replacement in such sensors, the longest possible battery lives are sought.

During a measurement cycle, such a wireless monitoring sensor typically goes through the following operational phases:
Performing the actual measurement;
Processing the measurement results;
Transmitting the measured data via an air or wireless interface;
Waiting until the next measurement.

The present invention is based on the idea of achieving energy savings in wireless transmission by compressing the data before transmitting it, for example to a gateway. To achieve a sufficient range for wireless data transmission, an external wireless module arranged in the respective sensor or working in conjunction with the sensor must emit a modulated electromagnetic wave with a minimum power via a respective antenna.

In a Bluetooth wireless connection, for example, this minimum power is 10 mW. Furthermore, the energy consumption for data transmission increases with the respective amount of data to be transmitted since the transmitter of the wireless module then has to transmit for longer. Said transmission phase therefore generally requires substantially more energy than, for example, said data processing phase. Furthermore, even in situations where the time of a measurement cycle falls below a specified value, the required transmitting energy far exceeds the energy consumption during said waiting phase. Therefore, in these cases, the total energy during a measurement cycle can be substantially reduced simply by saving on the transmitting energy.

In order to minimize the overall energy consumption of battery-operated wireless sensors, the energy consumption must be considered as the sum of the following technical energy contributions:
Waiting until the next measurement: microcontroller in low power mode;
Measurement: microcontroller and MEMS active;
Data processing of the measurement results, for example using the method described below based on the RMS (root mean square) value: microcontroller active;
Data transmission: microcontroller and wireless module active (starting point of the solution according to the invention).

For said data compression according to the invention, use is made of compression methods known per se for time series data, these being described, for example, in “Giacomo Chiarot and Claudia Silvestri “Time Series Compression Survey”, in ACM Computing Surveys 55.10 (February 2023), pp. 1-32.”, and being fully incorporated herein by reference.

The delta method described therein is particularly suitable for compressing time series of temperature values since, at the beginning of a measurement, the first temperature value is transmitted absolutely (for example 20° C.), and subsequently only the differences from the first value are transmitted (for example +1 instead of 21° C.). In the present case, the differences from the previous value are smaller than the absolute values, so fewer digits are required for the values to be transmitted and therefore the amount of data to be transmitted can be reduced using “run-length binary encoding”. In the case of vibrations, this requirement does not apply in the time domain since two consecutive acceleration values can differ by the size of the entire measuring range.

It should be noted here that the following compression methods, also known in the prior art, for sensor signals for monitoring sensors concerned here, for example vibration sensors, or corresponding characteristically related sensor data or vibration data, have proven to be unsuitable or not optimized for this application.

These known compression methods are:
Delta method used, for example, for temperature curves: In this method, the absolute measured value is transmitted initially and subsequently only changes {80° C., +1° C., −2° C., etc.} are transmitted in order to achieve smaller data sizes.
“Dictionary-based”: Here, the data are broken down into substrings (“words”) and the words are encoded. However, this only works reliably with repetitive data structures, for example texts. The disadvantage of this compression method is that the sender and recipient have to exchange their shared dictionary before the data are transmitted.
“Run-length encoding”: In this case, identical substrings in the input data are no longer transmitted individually, but rather the number of repetitions=run length, for example the pixel colour in image data correspondingly {run length=5, black} instead of {black, black, black, black, black}.
“Run-length binary encoding”: Leading zeros are omitted here, that is to say as follows:
{00001110, 00001101, 00001001, 00011111, 00010101, etc.->{run length=3, data size=4, 1110, 1101, 1001, run length=2, data size=5, 11111, 10101, etc.}.
“Huffman coding”: What is referred to as “entropy coding.”

Reducing the size of the data to be transmitted therefore results in higher energy efficiency and thus a longer battery life. For example, measuring and transmitting 256 vibration values every 60 seconds from a sensor node in a “MiraMesh” network, that is to say using two battery cells with an electrical charge of 2600 mAh each and a voltage of 3.6 V, resulted in a battery life of 13.5 years without data compression and 22.6 years with data compression.

The approach according to the invention enables the lossless, wireless transmission of, for example, acceleration or vibration data, as described in detail below. The measurement data detected in the time domain is first transformed from the time domain into the frequency domain here. The compression algorithm which is applied to the data transformed in this way and is described in detail below can in particular also be implemented in microcontrollers, such as those provided in said sensor nodes. The compression algorithm itself consumes significantly less energy here than the transmission energy saved by the compression. At the respective data recipient, the spectrum generated by the transformation into the frequency domain can either be analysed directly or transformed back into the time domain.

It should be noted that, due to the lower data traffic in the air through the wireless transmission, even more sensors can advantageously be integrated into a given sensor network.

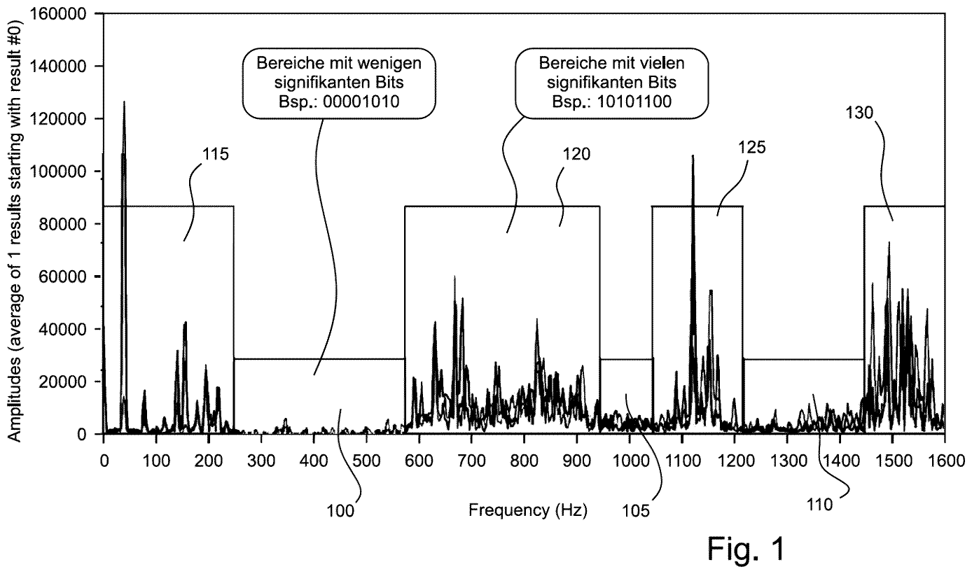

FIG. 1 shows an example of the amplitude spectrum of a vibration sensor in the example frequency measurement range from 0 to 1600 Hz.

The compression method according to the invention in this exemplary embodiment of a vibration sensor is based on the exploitation of the following special properties of detected vibration data. For example, defects and anomalies in a machine, system or system component monitored by a vibration sensor generate temporally periodic signals. In the frequency range of 0 to 1600 Hz concerned here, the vibration data transformed into the frequency domain and digitized accordingly also contain ranges with many significant bits, that is to say consecutive data with only a few leading zeros, as well as ranges with only a few significant bits, that is to say consecutive data with many leading zeros (see FIG. 1). It should be noted here that this behaviour only occurs in the frequency domain, but not in the time domain.

According to the method according to the invention for operating a wireless monitoring sensor concerned here, the energy required for transmitting the measured data can be reduced by compressing the measured data before transmission. In order to enable the recipient to completely reconstruct the transmitted data by decompression, compression is carried out that with as little loss as possible.

In this exemplary embodiment, the invention is based on the empirical knowledge that the mostly periodic vibration data, for example in the case of mechanical defects typically occurring in a machine rotary bearing, usually occur at a multiple of the respective rotational frequency. In the frequency range concerned here, corresponding vibration spectra generated from the detected time series data, for example by means of the “fast Fourier transformation” (FFT) method, therefore exhibit, on the one hand, pronounced narrow lines with high amplitude and, on the other, frequency ranges with small amplitudes. Such or similar spectra can now be generated in the sensor itself by means of a microcontroller arranged in the respective sensor using an efficient method such as said FFT method.

FIG. 1 shows the result of such an FFT which outputs the vibration amplitudes with a resolution of 16 bits, corresponding to decimal numbers from 0 to 65535. In the ranges 100, 105 and 110 with small amplitudes, the leading or higher-value bits are zero, and only a few lower-value, significant bits carry the information. In contrast to ranges 115, 120, 125 and 130, these ranges 100-110 are particularly well suited to the data compression concerned here since the leading zeros can be completely omitted before transmission without any loss of information.

It should be noted that “run-length binary encoding” can generally be used as a compression method for the data in the frequency range present here. In principle, the “run-length binary encoding” method can be applied to data in both the time and frequency domains. However, in the case of vibration data, “run-length binary encoding” does not result in a high compression rate in the time domain.

In the “run-length binary encoding” method, measured values of the same data size are combined to form a bit sequence. For example, if the first eight bits of three consecutive 16-bit-wide measured values are zero, then it is sufficient to transmit the remaining eight significant bits in a sequence. The actual data is preceded by a header here containing the number of values belonging to the sequence, that is to say the run length of the sequence, as well as the data size of the sequence. The recipient can use the run length and the data size to reconstruct the original data by placing the correct number of zeros in front of the data. At the end of the sequence, the recipient expects a new sequence with a new header. The sequence formed in this way contains an additional header compared to the raw data. However, this disadvantage is offset by the leading zeros saved here.

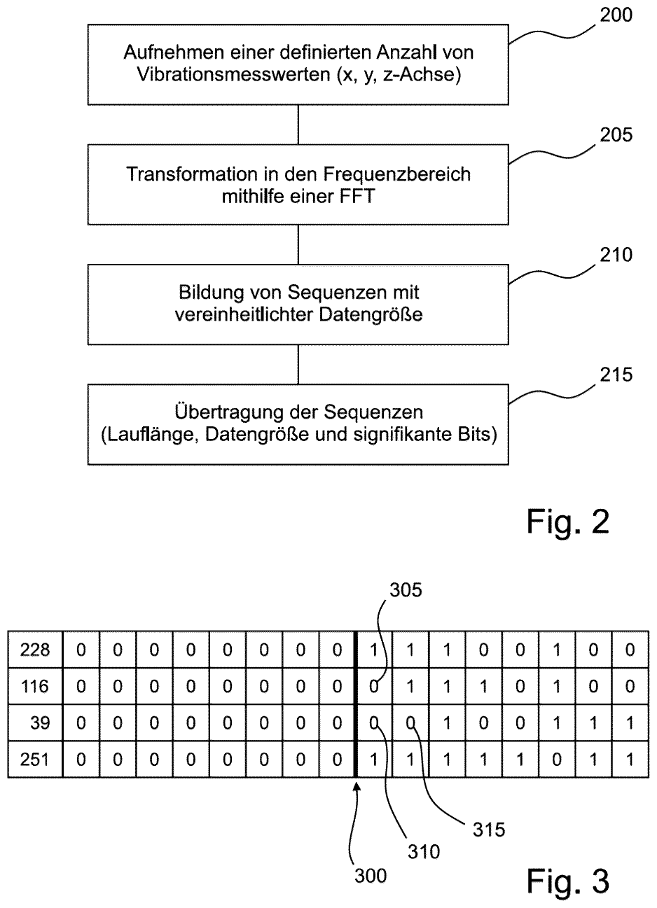

FIG. 2 shows process steps of the compression method according to the invention using a first exemplary embodiment. These process steps relate to a wireless vibration sensor concerned here which has said microcontroller and is further developed accordingly.

In a first process step 200, a defined number of vibration measurement values are recorded, that is to say, in the present exemplary embodiment, oscillation or vibration values in the three spatial directions x, y and z. In the second step 205, the vibration measurement values recorded in step 200 are transformed into the frequency domain by means of FFT. With the resulting frequency values or corresponding data, bit sequences of a standardized data size are formed 210. These bit sequences are then wirelessly transmitted 215, with essentially only the run length of the sequences, the data size and the significant bits being transmitted in the manner described.

This compression method therefore essentially includes the following two process features:
Application of “run-length binary encoding” to data transformed from the time domain into the frequency domain in said spectral range;
Standardization of the data size of a bit sequence or standardization of data sizes of existing bit sequences.

FIG. 3 shows examples of original vibration data and bit sequences generated by standardizing the data size. The four decimal values “228”, “116”, “39” and “251” are only a portion of a spectrum present overall here. The four values together require a total data size of 4*16 bits=64 bits, with the number of unused bits being 8+9+10+8=35 bits. In binary representation, one can see that the data size without leading zeros is 8, 7, 6 and 8 bits, so the formation of a bit sequence of the same data size is not possible.

The method according to the invention applies the data size 8 to all four of these values. This process is called “standardization”. A sequence of length 4 and data size 8 is formed from the data to the right of the drawn line 300. A value less than 8 cannot be chosen since otherwise a significant bit from lines “228” and “251” would be lost. In the present example, the standardization results in three bits 305, 310 and 315 remaining unused. The sequence formed to the right of line 300 contains a leading zero in line “116” and two leading zeros in line “39.” However, these unused bits 305-315 are compensated for by the fact that no further headers are required for a new sequence. Standardization is therefore particularly advantageous in ranges where the data size fluctuates by a few bits.

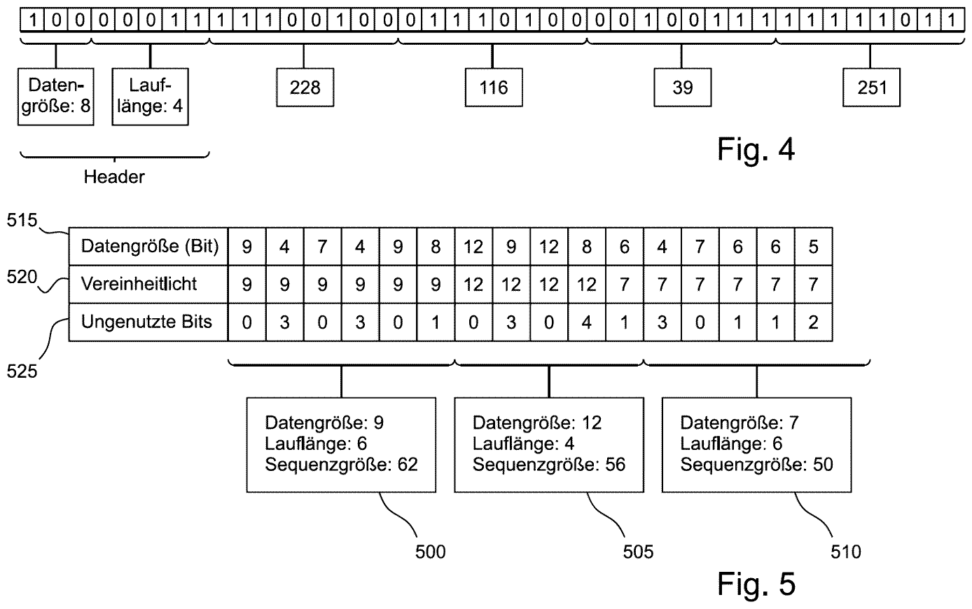

FIG. 4 shows an example of compressed data after standardization, as sent by a monitoring sensor transmitting measured data. In this example, the data size is 8 bits and the sequence size is 4*8+8=40 bits. The number of unused bits here is 3 (see the four highlighted bits). Compared to the original vibration data from FIG. 3, this results in a compression ratio of 40/64=62.5%.

FIG. 5 shows a numerical example of a standardization of three consecutive sequences to illustrate the process flow intended for standardization in which the sequences are formed by minimizing the total data size. In this example, the three sequences 500, 505 and 510 together comprise 25 values of the spectrum present here. The numerical values themselves are omitted in FIG. 5, unlike in FIG. 3. The first line 515 represents the respective data sizes of the bit values. The second line 520 specifies the standardized data sizes of the three resulting sequences.

According to the following equation:

$$Sequence size = data size * run length + header size \qquad ( Equation 1 )$$

the first sequence 500 has a sequence size of 9*6+8=62 bits. According to the equation (Equation 1), all three sequences 500-510 together have a data size of 62+56+50=168 bits. By comparison with the uncompressed case which has an overall size of 25*16=400 bits, this example therefore results in a compression ratio of 168/400=42%.

The algorithm for forming sequences of a standardized data size processes the values of the spectrum sequentially and forms corresponding sequences according to the second line 520. The data size and the run length of the sequence are optimized here to form the longest possible sequences, thus requiring as few headers as possible, while at the same time also avoiding too many unused bits, as shown in the third line 525 in FIG. 5.

If values of a larger data size than those of the current sequence occur, a new sequence has to be started, as illustrated in FIG. 5 at the transition between the first sequence 500 and the second sequence 505. In addition, if the number of unused bits in a sequence increases too much, a new sequence with a smaller data size is started, as illustrated in FIG. 5 at the transition between the second sequence 505 and the third sequence 510.

The method according to the invention can also be applied to binary bit sequences with negative numbers which can then be represented as a two's complement.

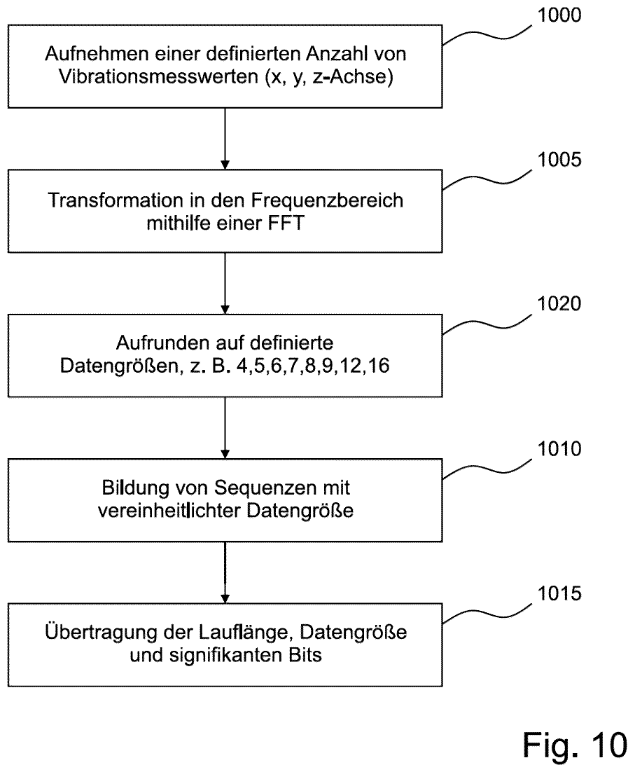

Furthermore, it is also possible not to allow all possible data sizes when sequences are being formed. In the exemplary embodiments described here, the data size can take the values 1 to 16. However, instead of 16 different data sizes, only 8 different data sizes can also be permitted. Different data sizes can be converted into permitted data sizes by rounding the data sizes up to respective values 4, 5, 6, 7, 8, 9, 12 or 16 before standardization instead of using the original values of 1 to 16. The permitted values are encoded using a table and the encoded values are transmitted in the header. This means that only 3 instead of 4 bits are required in the header to specify the data size (see FIGS. 4 and 10). The values are decoded by the recipient using the same table.

| Permitted value | Encoded value |
|---|---|
| 4 | 1 |
| 5 | 2 |
| 6 | 3 |
| 7 | 4 |
| 8 | 5 |
| 9 | 6 |
| 12 | 7 |
| 16 | 8 |

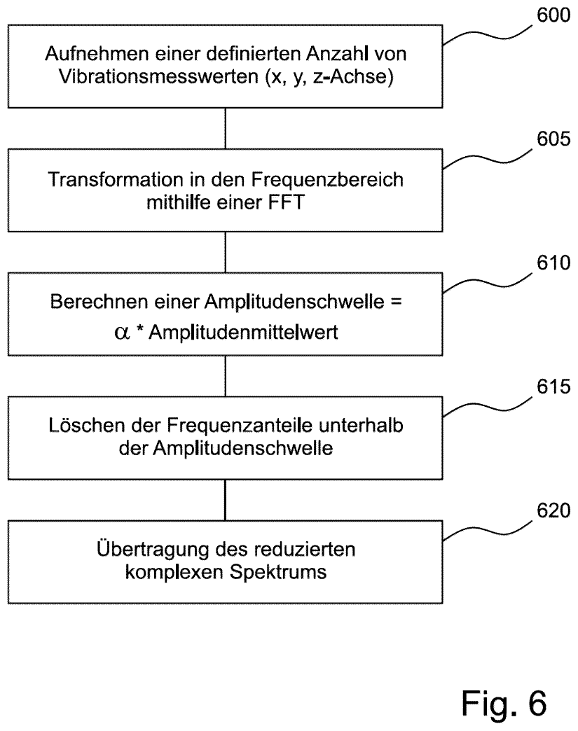

The second exemplary embodiment of the method according to the invention shown in FIG. 6 shows how the compression method disclosed herein can alternatively be carried out by deleting small frequency components.

As in the first exemplary embodiment shown in FIG. 2, a defined number of vibration measurement values is initially recorded in a first process step 600, that is to say in the present second exemplary embodiment also oscillation or vibration values in the three spatial directions x, y and z. In a second step 605 the vibration measurement values recorded in step 600 are also transformed into the frequency domain by means of FFT.

In contrast to the first exemplary embodiment, in the present second exemplary embodiment a specified amplitude threshold is calculated 610, that is to say by multiplying an amplitude mean value calculated beforehand using the transformed values by a factor α determined beforehand empirically. In the following step 615, all of the frequency components whose amplitude value is below the calculated 610 amplitude threshold are deleted from the existing data or values. Finally, the “complex” spectrum reduced in this way is transmitted 620 to a recipient (for example a gateway).

This method therefore consists of first transforming the measured data into the frequency domain and defining an amplitude threshold based on the values transformed in this way. It is advantageous here to define the amplitude threshold as a multiple a of the existing and easily determined amplitude mean value. All frequency components below this threshold can then be set to the value “zero” and only the “complex” frequency components with an amplitude above this threshold are transmitted. In the header, a list of deleted or undeleted frequencies must also be transmitted here in order for the transmitted real and imaginary frequencies to be shifted to the correct frequency by the recipient or for the untransmitted frequencies to be filled with zeros.

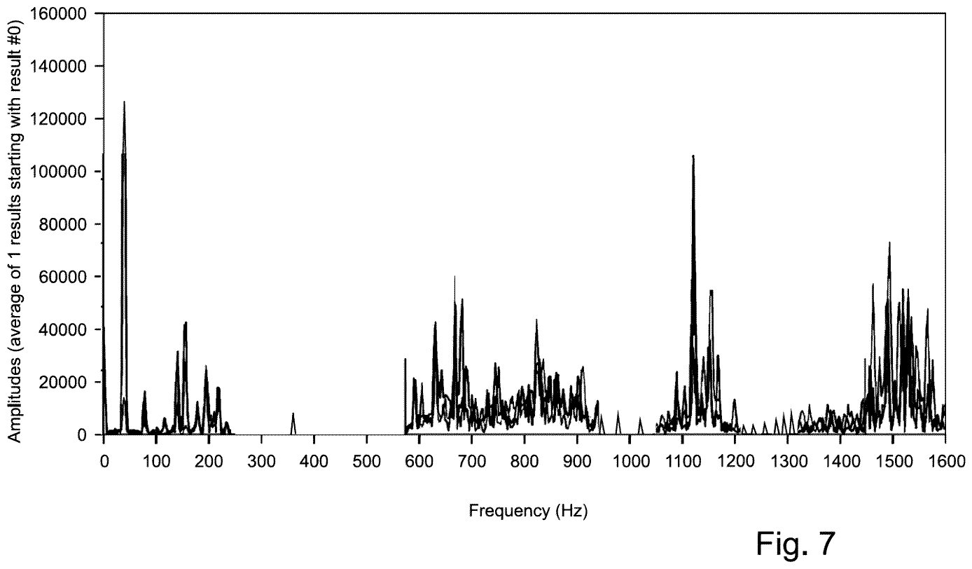

FIG. 7 shows an illustration of the second exemplary embodiment, that is to say an amplitude spectrum in the frequency range from 0 to 1600 Hz detected by a vibration sensor and already transformed by FFT. In the spectrum shown, all amplitudes smaller than a calculated amplitude threshold value have already been deleted.

However, this is a “lossy” compression, as described in more detail below. But since the smaller frequency components play only a relatively minor role in the reconstruction or back-calculation of (original) measured values from the FFT-transformed values, this method can be used to reconstruct the time course of the measured data with only minor errors for the respective recipient. The compression ratio achievable in this exemplary embodiment depends on the multiple a used in the calculation of the amplitude threshold and on the spectrum itself.

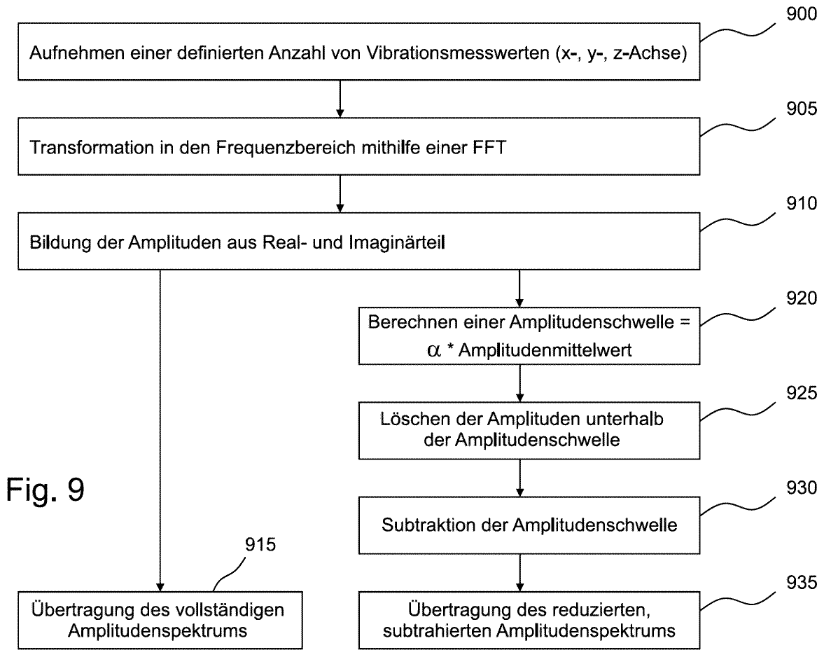

In a third exemplary embodiment, the measured data are transformed into the frequency domain and then, instead of transmitting the complex spectrum (including real and imaginary parts), only the amplitude values themselves are transmitted (see FIG. 9, left column, process step 915 therein). This enables a compression ratio of even approximately 50%. However, since the recipient lacks phase information, the temporal course of the vibration data taking place in the time domain can no longer be reconstructed from the amplitude spectrum. This is therefore a lossy compression.

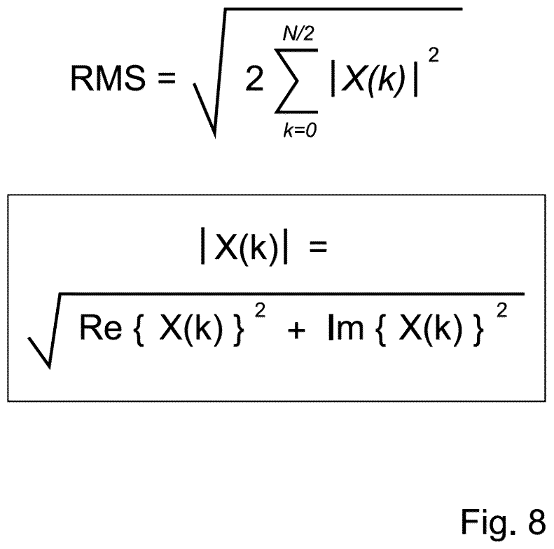

According to the equation shown in FIG. 8, in some cases of lossy data compression it is sufficient merely to identify frequencies with large amplitudes for the necessary error analysis in order to draw inferences on the condition of a particular machine to be monitored. This is because the method described herein makes it possible to calculate the RMS value (“root mean square” value according to the equation shown in FIG. 8) of a measured vibration at the respective data recipient since this can be calculated not only from the time data but also from the amplitude spectrum according to the known “Parseval's theorem”, with X(k) being the complex values in the frequency domain.

In the fourth exemplary embodiment of the method according to the invention shown in FIG. 9, as in the first exemplary embodiment shown in FIG. 2, a defined number of vibration measurement values is initially recorded in a first process step 900, that is to say in the present second exemplary embodiment also oscillation or vibration values in the three spatial directions x, y and z. In a second step 905 the vibration measurement values recorded in step 900 are also transformed into the frequency domain by means of FFT.

According to a second procedure, an amplitude threshold value is formed 920 from the amplitude values consisting of real and imaginary parts that exist after step 910, that is to say again by multiplying an amplitude mean value calculated as already described as a multiple a of the respective existing amplitude mean values. Accordingly, all frequency contributions below the threshold value formed in this way are deleted 925.

Since all of the amplitude values of the spectrum existing after this selection step 925 are larger than the threshold value, it is possible to subtract 930 the threshold value from the remaining amplitude values without negative amplitude values being able to occur. The reduced and subtracted amplitude spectrum has a reduced value range and can therefore be transmitted to a recipient in the subsequent step 935 with a smaller data size and thus lower transmission energy. At the recipient, only the threshold value needs to be added to the then existing amplitude values and the transmitted frequencies need to be shifted to the respectively correct frequency positions in order therefore to obtain the correct amplitude spectrum. For this purpose, the threshold value must be transmitted wirelessly together with the compressed data.

In the fourth exemplary embodiment, it is also advantageous to additionally apply or combine the compression approach described above with reference to FIG. 2 to the reduced and subtracted amplitude spectrum, that is to say the omission of the leading zeros and the standardization of the data size, in order to achieve a further reduction in the amount of data to be transmitted.

FIG. 10 shows a further addition to the fourth exemplary embodiment shown in FIG. 9. After recording 1000 a defined number of vibration measurement values and transforming 1005 the recorded vibration measurement values into the frequency domain by means of FFT, bit sequences with a standardized data size are formed 1010. Before forming 1010 the bit sequences with a standardized data size, a rounding up 1020 to defined data sizes, for example to data sizes of 4, 5, 6, 7, 8, 9, 12 or 16 bits, is also carried out here. This means that it is sufficient to transmit 1015 only the run length, the data size and the significant bits (for the definition of these sizes, see, for example, FIGS. 4 and 5). Optionally, an amplitude threshold can also be formed here and all frequency contributions below this threshold can be deleted (as in the second exemplary embodiment, for example). Since all of the amplitudes of the spectrum are greater than the threshold value due to this selection, it is also possible here to subtract the threshold value from the amplitude values of the remaining amplitudes without resulting in negative amplitude values.

In addition to the steps of the described method (see FIGS. 2, 6 and 7), further compression methods are also possible here before transmitting the data according to the prior art.

1. Method for the energy-efficient operation of a wireless monitoring sensor for detecting time measurements, characterized in that measured values detected by the monitoring sensor in the time domain are transformed into the frequency domain in order to generate a frequency-dependent amplitude and phase spectrum in a predetermined frequency range, in that the overall size of the resulting bit data is reduced by compression, with bit data of the same data size being combined to form a bit sequence, in that bit sequences having the same number of significant bits, that is to say bits having the same number of leading zeros, are wirelessly transmitted to a recipient reduced by the number of leading zeros and combined accordingly, and in that the combined bit sequences are decoded again by the recipient, with the data with the reduced leading zeros being supplemented again.

2. Method according to claim 1, characterized in that the compressing of the bit data is carried out using a “run-length binary encoding” method.

3. Method according to claim 1, characterized in that the data size of a bit sequence and the data sizes of existing bit sequences with a similar number of leading zeros are standardized before compression.

4. Method according to claim 1, characterized in that an amplitude threshold is determined on the basis of the amplitude spectrum, with only amplitudes above the amplitude threshold being transmitted to the recipient.

5. Method according to claim 4, characterized in that the determined amplitude threshold is determined as a multiple of an amplitude mean value ascertained from the amplitude spectrum.

6. Method according to claim 1, characterized in that a predetermined number of measured values is detected in the time domain, in that the detected measured values are transformed into the frequency domain by means of Fourier transformation, in that bit sequences are standardized in respect of their data size, and in that the resulting bit sequences are wirelessly transmitted to the recipient.

7. Method according to claim 1, characterized in that, when sequences are being formed, not all possible data sizes are permitted, with data sizes being rounded to respective values before standardization of the data size.

8. Method according to claim 6, characterized in that the run length of the bit sequences, the data size of the bit sequences and significant bits are transmitted to the recipient.

9. Method according to claim 1, characterized in that the data resulting from the transformation into the frequency domain are compressed by deleting frequency components with relatively small amplitudes.

10. Method according to claim 1, characterized in that all of the frequency components whose amplitude value is below the amplitude threshold are deleted from the data resulting from the transformation into the frequency domain.

11. Method according to claim 1, characterized in that, instead of transmitting a complex amplitude spectrum, only the amplitude values themselves are transmitted, with a list of the deleted or undeleted frequencies also being transmitted.

12. Method according to claim 1, characterized in that amplitude values are formed from the real and imaginary parts and the complete amplitude spectrum formed in this way is transmitted.

13. Method according to claim 12, characterized in that bit sequences with a standardized data size are formed and only the run length, the data size and the significant bits are transmitted.

14. Method according to claim 1, characterized in that the amplitude spectrum generated by the transformation into the frequency domain is analysed directly by the recipient of the transmitted bit data or transformed back into the time domain.

15. Wireless monitoring sensor for detecting time measurements, characterized by a microcontroller for energy-efficient operation according to the method according to claim 1.
